(19) United States
(12) Patent Application Publication
(10) Pub. No.: US 2024/0245010 A1
(43) Pub. Date: Jul. 25, 2024

(54) Modular Growth Unit for a Vertical Farming System

(71) Applicant: Ocado Innovation Limited, Hatfield, Hertfordshire (GB)

(72) Inventors: Stephen MILLWARD, Hatfield, Hertfordshire (GB); Andrew INGRAM-TEDD, Hatfield, Hertfordshire (GB)

(73) Assignee: Ocado Innovation Limited, Hatfield, Hertfordshire (GB)

(21) Appl. No.: 18/565,907

(22) PCT Filed: May 31, 2022
(86) PCT No.: PCT/EP2022/064785

§ 371 Date: Nov. 30, 2023

(30) Foreign Application Priority Data
Jun. 2, 2021 (GB) 2107911.6
Nov. 19, 2021 (GB) 2116750.7

(51) Int. Cl. A01G 9/02; A01G 9/24

(52) U.S. Cl. CPC A01G 9/022; A01G 9/249

(57) ABSTRACT

A modular growth unit for forming a three dimensional extendible structure, the modular growth unit including a top wall, a bottom wall and sidewalls to define a box like structure. The top and bottom walls include an interlocking feature to interlock modular growth units when placed in a stack. The bottom wall has a rim to define a growth tray for receiving a growth medium for living organisms. The top wall supports a lighting unit to radiate light within at least one spectral region associated with the growing living organisms. A sidewall window has an opening extending into an interior space of the box-like structure so that the interior space is accessible.

### FIELD OF THE INVENTION

The invention relates to a farming system, method and related devices. More specifically the invention relates to indoor farming techniques. In some arrangements the indoor farming system may be laid out over multiple levels as a vertical farm.

### BACKGROUND

Conventional systems and methods for growing crops are well known. Most require large areas of arable land, abundant quantities of water, and in many commercial farming operations, large amounts of chemicals, including herbicides, pesticides and fungicides. In recent years, there is a growing number of technologies offered for improving efficiency, productivity, land use, labour usage, and cost expenditure in farming plants and crops. Indoor farming under artificial lights is gaining popularity for a large number of crops.

More recently, advanced farming techniques such as hydroponics, aeroponics and other such cultivation systems have led to the ability to grow high quality crops indoors with very high utilisation of lighting, water and fertiliser. As implied by its name, hydroponics involves suspending the plant roots directly within a pool of water or supported in a growth medium such as perlite or gravel which is saturated with water. The water comprises nutrients so as to promote plant growth.

A number of hydroponic techniques have been developed, including: continuous-flow hydroponics wherein the nutrient solution slowly flows past the plant roots; drip hydroponics, where nutrient solution is pumped from a reservoir to slowly drip onto the top surface of the growth medium and flow past the roots before being recycles in the nutrient; flow hydroponics, wherein the container in which the plant is grown is continuously flooded with nutrient solution and then allowed to drain; and deep water culture, wherein the plant roots are suspended within the water/nutrient solution whilst an air pump bubbles oxygen into the solution to be taken up by the plant roots. Whilst hydroponic systems provide a closed growing environment removing the need for harmful chemicals, systems based on hydroponics still remains a water-intensive alternative to conventional systems.

Unlike hydroponics, aeroponics is a process of growing plants using air as the growth medium. In aeroponics, the plant roots are suspended such that the plant roots receive water and other nutrients through an atomized spray of nutrient-laden water commonly referred to as “nutrient tea”. Usually, an atomizer or mister aerosolizes the tea directly onto the plant roots. As a result, aeroponics offers advantages over hydroponics, which requires a growth medium, by having the plant roots suspended within air increasing the availability of oxygen and carbon dioxide to the plant roots.

To increase the yield of plants over a given footprint, there have been a move towards vertical farming methods, in which plans are grown in generally a vertical structure.

An example of an indoor farm is disclosed in WO2020/030825 A1 “HYDROPONICS growing system AND METHOD” (Ocado Innovations Ltd.), the contents of which are incorporated herein by reference. WO'825 describes an apparatus (100) for use in a hydroponic growing system is described. The apparatus comprises a frame (F) of vertical members and horizontal members supporting horizontal tracks or guideways on which a set of growing vehicles (120) are mounted. The growing vehicles each contain a number of growing trays in which plants or crops (C) are accommodated whilst they grow.

Some commercial and industrial activities require systems that enable the storage and retrieval of a large number of different products. Another example of an indoor farm is disclosed in WO2018050816A1 “Growing Systems And Methods” (Ocado Innovations Ltd.), the contents of which are incorporated herein by reference. WO'816 describes a growing system where plants are grown in containers 110, and the containers are stored in stacks. Above the stacks, load handling devices run on a grid network of tracks 16 and take containers from the stacks and deposit them at alternative locations in the stacks or at work stations 10. The containers are provided with services and deployable lighting means. The provision of these such lighting means within individual containers rather than across the system as a whole, allows for flexibility in storage whilst reducing cost and inefficiency and enables multiple crops to be grown in a single area.

U.S. Pat. No. 10,555,466 (Daegan Gonyer et al) teaches a growth system for growing vegetation and includes a plurality of modular growth units defining a vegetative zone; a plurality of lighting units including a lighting node for selectively emitting first and/or second wavelengths of light in the vegetative zone; an unpressurized reservoir for housing a fluid containing one or more nutrients; a nutrient feeding system for fluidly connecting each of the modular units to the reservoir in parallel; and a pump in fluid communication between the reservoir and the modular units. When a modular unit is connected to the respective quick connect valve, the nutrient feeding system directs the fluid to the modular unit, and when the modular unit is disconnected from the valve, the valve is configured for preventing the fluid from flowing from the reservoir through the valve, and the other modular units connected to the nutrient feeding system remain fluidly connected to the reservoir. A number of irrigation lines in the form of piping and/or tubing from the reservoir comprising the plant nutrients are normally fed to the individual growth trays of the vertical farming unit usually via various couplings or connectors on the vertical farming unit such that each growth medium of the vertical farming unit receives an adequate supply of nutrients to promote plant growth.

However, the problem with indoor farming systems known in the art is that they require an intensive supply of water and/or nutrients to feed the plants in comparison to conventional farming techniques resulting a network of irrigation lines in the forms of various piping and/or tubing to transport the water and/or nutrients from the water and/or nutrient source, e.g. reservoir, to the crops. Even with the use of aeroponic techniques to limit the use of water and/or nutrients by atomizing the solution into a mist, there is still a requirement to use extensive piping and/or tubing to transport the solution or tea from a source reservoir to the atomizer or misters. The problem is exacerbated when the plants are located in a number of vertical farming units comprising multiple layers of trays containing soil and/or growth media for growth of plants. Feeding the individual pipes and/or tubing around the vertical farming unit results in a spaghetti of piping and/or tubing in and around each vertical farming unit. The greater the length of piping and/or tubing used, the more susceptible the pipes to the entrapment of air and the greater the requirement to regularly bleed the pipes to remove trapped air, as this will have an impact on the controlled dosage of nutrients to anyone of the plants in a vertical farming unit. Not only is there a requirement to the extensive use of lengths of piping and/or tubing, but also there is a need to pump the nutrients through the piping. In some cases, a relatively large pump system would be required to provide an adequate pressurised system within the network of irrigation lines.

WO2020178696 (Advanced Intelligent Systems Inc.) has attempted to overcome this problem by providing an agricultural robot comprising a chassis comprising a plurality of ground-engaging mechanisms for propelling the robot in a direction of travel, a supply module mounted on the chassis and comprising a fluid providing unit comprising a fluid reservoir, a power providing unit, a supply interface operatively connected to the fluid providing unit and to the power providing unit and for providing at least one of fluid and power, and a controller for operating the plurality of ground-engaging mechanisms and the supply interface. Thus, instead of feeding nutrients to the plants via a network of irrigation lines, the agricultural robot is equipped with the necessary tools and supply of nutrients to travel to a vertical farming unit and feed the plants. This has the advantage that it may reduce or eliminate the need for lengthy wiring and tubing systems from a static fluid and from the power sources by bridging the gap between static facilities and mobile vertical farming units, increasing the mobility and modularity of vertical farming units using mobile multi-shelf apparatuses within the greenhouse space as needed. However, the downside of using an agricultural robot to transport nutrients to the vertical farming unit is the limited capacity of the fluid providing unit. The fluid providing unit typically comprises a fluid reservoir comprising one or more containers carried by the robot. However, the fluid capacity, and thus nutrients carried by the robot, is dependent on the ability of the robot to carry the one or more containers. Sometimes, frequent visits may be necessary between a replenishing unit and the same vertical farming unit in order that each growth media has an adequate supply of nutrients.

WO2019/195027 (Alert Innovation Inc.) teaches a vertical farming system comprising a storage structure having racks of storage shelves for housing plant-carrying containers Mobile robots travel around the racks to transfer containers of plants to and from the storage shelves. Under direction of a central control system, one or more mobile robots may transport a container from a storage location to a workstation. Once there, care may be provided for the plant, including water and/or other nutrients, and data may be gathered on the plant. This may be done by an owner of the plant, or by an automated service robot positioned at the workstation. Data gathered on the plant, including for example photographs, may be sent by email or other communications schemes to an owner of the plant. However, the mobile robot is very much limited to retrieving a single container from the storage structure and transporting it to the workstation. To retrieve multiple containers, more than one mobile robot is required to transport the containers to multiple workstations.

Thus, there is a need for a system and method that will provide an efficient growing system in terms of the use of assets, resources and services required for germinating, propagating and growing living organisms to maturity before harvesting that does not suffer from the above problems.

### SUMMARY OF THE INVENTION

The present invention has mitigated the above problem by providing a modular growth unit for forming a three dimensional extendible structure, the modular growth unit comprising a top wall, a bottom wall and sidewalls extending between the top wall and bottom wall to define a box like structure having an interior space, the top and bottom wall comprising at least one interlocking feature so as to enable one modular growth unit to interlock with another modular growth unit when placed on top of each other in a stack, the bottom wall having a rim around the perimeter of the bottom wall so as to define a growth tray for receiving at least one growth medium for germinating, propagating and/or growing living organisms, and the top wall supporting a lighting unit configured to radiate light within at least one spectral region associated with the growing living organisms within the interior space of the box-like structure;
characterised in that a sidewall of the box like structure comprises a window having an opening extending into the interior space of the box-like structure so that the interior space of the modular growth unit is accessible externally through the window.

In this description, the terms “modular growth unit” and “modular growing unit” are used interchangeably.

For the purpose of the present invention, living organisms is understood to include all Eukaryota (Plantae, Fungi, Animalia), that is, all multicellular plants, fungi and animals; and all Prokaryota (Bacteria, Archaea, Protozoa, Chromista), that is, all unicellular microorganisms such as protists, bacteria, and archaea.

Growing living organisms in trays in a vertical farming system suffers from the problem that the trays would need to be supported in a storage structure comprising a plurality of racks of storage shelves such that mobile robots would need to travel around the racks to transfer the trays to and from the storage shelves. For living organisms that require light in order to grow, any lighting system to enable the living organism to grow would have to be integrated into the storage structure, and therefore would be separate from the trays containing the living organism. As a result, the trays containing the living organism would have to be returned to a shelf in the storage structure in order to continually receive light emitted by the lighting system above. Any one of the trays kept away from the storage structure for any length of time has the effect of disrupting the ability of the living organism to absorb a sufficient quantity of energy from the lighting system over a period of time in order to achieve full photosynthesis. As living organisms are grown on an industrial scale and sometimes over a fixed period of time, any disruption to the ability of the living organism to absorb energy from the lighting system will ultimately affect both the yield and the quality of the living organism, in particular the quality of the crop.

In the present invention, living organisms are grown in modular growth units comprising a top wall, a bottom wall and sidewalls extending between the top and bottom wall so defining a box-like structure having an interior space housing a growth medium for germinating, propagating and/or growing living organism, a growth tray for receiving the growth medium, and a lighting unit configured to radiate light within at least one spectral region associated with the growing living organisms. In the case where the living organisms are plants, a growth medium is a material where plants can develop their roots and is dependent on whether a hydroponic or aeroponic system is used. If a hydroponic system is used, the growth medium can include but is not limited to perlite, vermiculite, rockwool, coconut coir or a combination thereof. However, no growth medium is necessary in an aeroponic system as the plant roots are misted with a nutrient solution and do not have access to standing water as they would in a hydroponic system.

The top wall supports the lighting unit and comprises an array of light emitting diodes that is selected to radiate at least one spectral region associated with growing living organisms. Preferably, the lighting unit comprises an array of light emitting diodes that is able to radiate different wavelengths of light to control the growth of the living organism. For example, green wavelengths are reflected and transmitted more strongly by plant leaves than the red and blue wavelengths, which are absorbed more efficiently within leaves for photosynthesis. In the case where the living organisms are plants, instead of growing the living organism in trays, the box-like structure of the modular growth unit according to the present invention allows all of the essential elements for photosynthesis to be supported within the box-like structure removing the need to separate one or more elements of photosynthesis, e.g. light, when transporting the living organism.

The bottom wall has a rim or lip around the perimeter of the bottom wall so as to define a tray. To care for the living organism externally of the modular growth unit, e.g. watering, nutrients etc., at least one sidewall comprises a window having an opening extending into the interior space of the modular growth unit. This allows the modular growth unit of the present invention to be transported to an automated service station, wherein the automated service station can gain access to the interior space containing the living organism externally of the modular growth unit and provide one or more services to care for the living organism such as watering, nutrients, drainage etc.

For economies of scale on an industrial scale, the top and bottom wall comprises at least one interlocking feature so as to enable one modular growth unit to interlock with another modular growth unit when placed on top of each other in a vertical stack. This allows multiple modular growth units to be stacked one on top of the other allowing the living organism to be vertically farmed. Preferably, the interlocking feature comprises a male type interlocking feature and a female type interlocking feature. Optionally, the interlocking feature are in the form of a projection and/or a depression that are complimentary in shape.

To enable the modular growth unit of the present invention to be used for forming a three dimensional extendible structure, preferably, the modular growth unit is substantially parallelepiped in shape. Optionally, the modular growth unit is substantially cuboidal or cubic in shape such that the modular growth unit is interlockable with other modular growth units at two surfaces substantially opposite to each other.

To provide power to each of the lighting units when a plurality of modular growth units are arranged in a stack, preferably, the modular growth unit comprises an electrical interface for electrically coupling with another modular growth unit in the stack. Preferably, the electrical interface is integrated into the interlocking feature such that when multiple modular growth units are stacked, electrical continuity is established between adjacent modular growth units in the stack. Preferably, the electrical interface comprises a charge collector that is configured for coupling with a charge provider so as to provide power to the lighting unit. For example, the charge provider can be integrated into the floor such that when the modular growth unit is mounted on the floor, the charge provider electrically couples with the charge collector of the modular growth unit. The charge provider provides an external source to the lighting units. Optionally, the modular growth unit further comprises at least one rechargeable power source electrically coupled to the charge collector for providing power to the lighting unit. Optionally, the rechargeable power source is any one of a capacitor, supercapacitor and/or battery. Optionally, the charge collector comprises a wireless charge receiving coil that is arranged for inductively coupling with a charge transmitter coil of the charge provider. Alternatively, the charge collector comprises at least two charge receiving elements that are configured for receiving a direct current from at least two charge providing elements of the charge provider.

Optionally, the charge collector is configured for coupling with a charge provider so as to provide power to one or more electrically powered devices for providing services to the living organisms. The one or more electrically powered devices for providing services to the living organisms may comprise a heating element, a sensor, or a status indicator.

The modular growth unit of the present invention provides a vertical farming system, comprising:
i) a growth station comprising one or more modular growth units, each of the one or more modular growth units comprising a modular growth unit according to the present invention;
ii) a service station for providing one or more services to each of the one or more modular growth units, the service station comprising:
   (a) one or more reservoirs storing fluid containing one or more nutrients;
   (a) a nutrient feeding system comprising a fluid delivery system in fluid communication with the one or more reservoirs, said fluid delivery system being configured to removably couple to each of the plurality of modular growth units so as to deliver fluid to the growth trays of each of the plurality of modular growth units,
iii) a transport means for transporting the one or more modular growth units to and fro the growth station and the service station;
iv) a controller communicatively coupled to the at least one transport means, the controller comprising one or more processors and memory storing instructions that, when executed by the one or more processors, control the movement of the at least one transport means to transport each of the one or more modular growth units from the growth station to the service station.

In contrast to having lengthy tubing and/or wiring to each of the growth trays as found in prior art vertical farming systems, the modular growth units of the present invention are brought to a dedicated service station for providing one or more services to care for the living organism before being returned to the growth station. This has the advantage that the tubing and/or wiring for providing nutrients to the living organism is concentrated or contained to one or two regions of a warehouse housing the vertical farming system of the present invention and thereby, reducing the need for any lengthy tubing that needs to be fed to fixed or stationary vertical racks of storage shelves supporting the growth trays. In the present invention, a transport means is configured for transporting one or more modular growth units from the growth station to the service station. To automate the servicing of the living organisms, it is necessary that the fluid delivery system of the service station is able to releasably couple with one or more of the modular growth units, in particular their respective growth trays. Optionally, the fluid delivery system further comprises one or more delivery down pipes or tubes that are each configured to be removably receivable in the one or more trays of respective one or more of the modular growth units. To enable the one or more down pipes to be received within the growth trays, optionally, each of the one or more delivery down pipes is deformable so as to enable the one or more delivery down pipes to resiliently deform when butted up against the rim of the tray of the modular growth unit and return to its original shape when received within the tray. For example, the delivery down pipe can be formed of a resilient material that is able to flex or fold when the end of the delivery down pipe butts up against the rim of the growth tray. Further movement of the modular growth unit into the service station causes the delivery down pipe to return to its original shape so as to be received within the growth tray of the modular growth unit.

In addition to providing a fluid delivery system for feeding of the living organism, the service station can further comprise a fluid draining system for removing waste fluid from one or more growth trays. Like the fluid delivery system, the fluid drainage system can comprise one or more drainage down pipes or tubes that are configured to be removably receivable in the one or more trays of the respective one or more of the modular growth units. Preferably, each of the one or more drainage down pipes is deformable so as to enable the one or more drainage down pipes to resiliently deform when butted up against the rim of the tray of the modular growth unit and return to its original shape when received within the tray.

The at least one transport means can be an automated or autonomous guided vehicle (AGV) or autonomous mobile robot (AMR) that is configured to engage with a modular growth unit and tow the modular growth unit from the growth station to the service station for providing one or more services to the living organism such as feeding, watering etc. Optionally, the one or more modular growth units is mounted on a stand comprising a stand top and a plurality of legs extending downwardly from the stand top so as to allow the transport means to enter below the one or more modular growth units; the stand top comprising at least one interlocking feature that is configured to be interlockable with the at least one interlocking feature of a modular growth unit, and wherein the transport means comprises a lifting mechanism moveable between a raised position and a lowered position to raise the one or more modular growth units off the ground and lower the one or more modular growth units onto the ground respectively. By providing an intermediate stand between the modular growth unit and the at least one transport means, the transport means can quickly and efficiently lift and move one or more modular growth units without having to wait for the modular growth unit to be loaded onto the transport means. Furthermore, once the transport means has deposited the modular growth unit to a service station, the transport means is immediately free to go to retrieve another modular growth unit from the growth station without having to wait for the modular growth unit to be unloaded.

When the lifting mechanism is in the raised position, the height of the at least one transport means may be greater than the height of the stand top so that the stand together with the one or more modular growth units is lifted off the ground by the at least one transport means. When the lifting mechanism is in the lowered position, the height of the at least one transport means may be less than the height of the stand top so that the stand can rest on the ground with the at least one transport means underneath it. The lifting mechanism may comprise a lifting surface configured to be raised and lowered relative to the rest of the transport means. The lifting surface may engage the bottom of the stand top when in the raised position and disengage from the bottom of the stand top when in the lowered position. The top of the lifting surface may comprise one or more interlocking features (e.g. protrusions or recesses) configured to interlock with one or more corresponding interlocking features on the bottom of the stand top. The interlocking features on the lifting surface and the stand top help the modular growth unit to rest more securely on the transport means when being lifted and transported. The lifting mechanism may comprise a linear actuator for raising and lowering the lifting surface. The linear actuator may be any suitable type of actuator (e.g. pneumatic, hydraulic, electric, etc.).

The stand top may comprise a set of interlocking features on the top surface of the stand, configured to allow modular growth unit to interlock with the stand when mounted on the stand.

Where the electrical interface is integrated into the at least one interlocking feature of the modular growth unit, the interlocking features on the top surface of the stand may also comprise an electrical interface, thus allowing the modular growth unit to electrically couple with the stand through their respective interlocking features. One or more of the plurality of legs of the stand can additionally comprise an electrical interface that can electrically couple with an electrical source, e.g. charge provider, and since electrical continuity is established between the interlocking modular growth units, power can be transferred from the electrical source to each of the lighting units of the interlocking modular growth units in a vertical stack via the stand. Optionally, the service station comprises a charge provider or an electrical source that is configured for coupling with a charge collector. Advantageously, the one or more services provided by the service station is not only limited to services for caring of the living organism but also providing a source of electrical energy to charge the one or more rechargeable power sources incorporated into the one or more modular growth units.

Preferably, the one or more modular growth units comprises a plurality of stacks of modular growth units. The stack may comprise modular growth units of different heights. In the case, when one or more modular growth units are located on the stand, the modular growth units may be directly stacked on top of each other to form a vertical stack. Arranging modular growth units in a stack is an efficient way of densely packing the modular growth units. This is further made easy by the fact that each of the modular growth units has a box-like structure. Preferably, the plurality of stacks of modular growth units are arranged in a grid pattern. The ability of the individual modular growth units to interlock with each other provides freestanding stacks of modular growth units, removing the need to externally support the stacks of modular growth units.

The stand top and the plurality of legs defines a space underneath the stand top that is accessible by the at least one transport means from one or more openings defined between adjacent legs. A side opening may be defined on more than one side of the stand to allow the vehicle to move into the space from more than one direction. Two pairs of opposing side openings may be defined, with one pair being orientated orthogonal to the other pair. The stand top may have a rectangular shape with four legs extending downwardly from the four corners of the stand top. A side opening may be defined on each side of the stand, between each adjacent pair of legs. In this way, at least one transport means can move into and out of the space underneath the stand top regardless of the orientation of the stack unit. Furthermore, if the stack units are arranged in a grid pattern such that the side openings on adjacent stack units are aligned, then the at least one transport means can efficiently travel from one side of the grid pattern to another side by travelling “through” the grid pattern, rather than having to travel around the outside of the grid pattern. This also allows the stacked modular growth units to be more densely arranged because clear access routes are not required between the stacked modular growth units. Thus, whole stacks can be conveniently and efficiently transported and re-located around a facility by simply lifting the stand with the desired stack on top of it.

To care for the living organisms in the different stacks of modular growth units, preferably a controller is configured to instruct the movement of the at least one transport means to transport each stack of the plurality of stacks of modular growth units from the growth station to the service station periodically or in a predetermined sequence. Moreover, the controller is configured to instruct the movement of the at least one transport means to transport each stack of the plurality of stacks of modular growth units from the growth station to the service station in a predetermined schedule corresponding to the feeding cycle of a living organism. This allows the living organism to be provided with the correct amount of water and/or nutrients needed for healthy growth of the living organism. Optionally, the controller is configured to instruct the at least one transport means to move a first subset of the plurality of stacks of modular growth units from the growth station to the service station in a first schedule and a second subset of the plurality of stack of growing units from the growth station to the service station in a second schedule, the first schedule being associated with a first feeding cycle of a first type living organism and a second schedule being associated with a second feeding cycle of a second type living organism. The at least one transport means can transport a given stack of modular growth units to the service station depending on the servicing needs of the living organism, which can be associated with either the growth cycle or the type of living organism grown in each of the modular growth units in the stack. For example, the service station may additionally comprise an inspection device such as a camera or other device for inspecting the health and/or appearance of the living organism. Data collected from the inspection device can be used to provide the living organism with the right amount of nutrients and/or other care that is required to maintain the health of the living organism. The data collected can also be used to determine or calculate the schedule or frequency by which any given stack of modular growth units would need to be brought to the service station.

In addition to providing feeding nutrients to the living organism in the modular growth units, the service station can be a source of electrical power, specifically where the lighting units of the modular growth units are powered by a rechargeable power source. More specifically, the service station comprises a charge provider that is configured for coupling with a charge collector of a stack of modular growth units. The charge provider can wirelessly couple with the charge collector, or alternatively the charge provider can comprise two charge providing elements that are arranged to electrically couple with two charge receiving elements of the charge collector.

In the case where one or more types of living organisms require specialised care, optionally, the growth station comprises one or more enclosures, each of the one or more enclosures being configured to house the one or more modular growth units in a predetermined environment. The enclosure comprises a heater and/or humidifier so as to control the temperature and/or humidity in the enclosure.

### BRIEF DESCRIPTION OF THE DRAWINGS

Further features and aspects of the present invention will be apparent from the following detailed description of an illustrative embodiment made with reference to the drawings, in which:

FIG. 1 is a perspective view of a modular automated growing system according to an embodiment of the present invention;

FIG. 2 is a perspective view of a growth station comprising a plurality of vertical stacks of modular growth units arranged in a freestanding storage structure according to an embodiment of the present invention.

FIG. 3(a) and FIG. 3(b) is a perspective view of a single vertical stack of modular growth units shown in FIG. 2 in a (a) stacked arrangement; and (b) exploded arrangement.

FIG. 4 is a perspective view of a single modular growth unit shown in FIGS. 1 to 3.

FIG. 5 is a perspective view of the single modular growth unit of FIG. 4 showing the lighting unit mounted to the underside of the top wall.

FIG. 6(a) and FIG. 6(b) is a perspective view of an alternative modular growth unit according to an embodiment of the present invention comprising (a) two modular growth units in a stack; (b) a single elongated modular growth unit in a stack.

FIG. 7 is a perspective view of a single modular growth unit showing the electrical coupling between the modular growth unit and the stand.

FIG. 8 is a perspective view of a portion of the modular automated growing system showing a plurality of stacks of modular growth units for farming plant based living organisms.

FIG. 9 is a perspective view of a stack of modular growth units comprising a rechargeable power source for providing power to the lighting units.

FIG. 10(a), FIG. 10(b), and FIG. 10 (c) are perspective views of (a) an autonomous transport vehicle (AGV) entering below the vertical stack of modular growth units located on top of a stand, (b) the autonomous transport vehicle underneath the stand supporting the stack of modular growth units, and (c) the lifting mechanism of the autonomous transport vehicle lifting the stack to transport the stack according to the present invention.

FIG. 11 is a perspective view of an alternative lifting mechanism based on a fork lifting mechanism for transporting a stack of modular growth units according to the present invention.

FIG. 12 is a perspective view showing the removal of one or more stacks of modular growth units from the growth station comprising the plurality of vertical stacks of modular growth units arranged in the freestanding grid shown in FIG. 2.

FIG. 13 is a perspective view of the storage of the stack of modular growth units in one or more environmentally controlled enclosures.

FIG. 14 is a schematic flowchart of the service station showing the nutrient feeding system according to an example of the present invention.

FIG. 15 is a schematic flowchart of the service station showing the fluid drainage system according to an example of the present invention.

FIG. 16 is a perspective view of the service station for providing one or more services to the living organism according to an example of the present invention.

FIG. 17(a) and FIG. 17(b) is a perspective view of (a) a stack of modular growth units docked at the service station shown in FIG. 16, (b) engagement of the delivery and/or drainage down tubes or down pipes with the tray of the modular growth unit.

FIG. 18 is a schematic flowchart showing the relationship between the one or more service stations and the one or more transport means.

### DETAILED DESCRIPTION

Generally, the present invention provides a modular “plug and play” growth system which allows for efficient maintenance and/or expansion of individual modular growth units within the growing system without interrupting or otherwise disturbing the removal of other individual modular growth units. The growth system according to the present invention may simultaneously accommodate any number of modular growth units including but not limited to aeroponics, ebb and flow hydroponics, deep culture hydroponics and aquaponics.

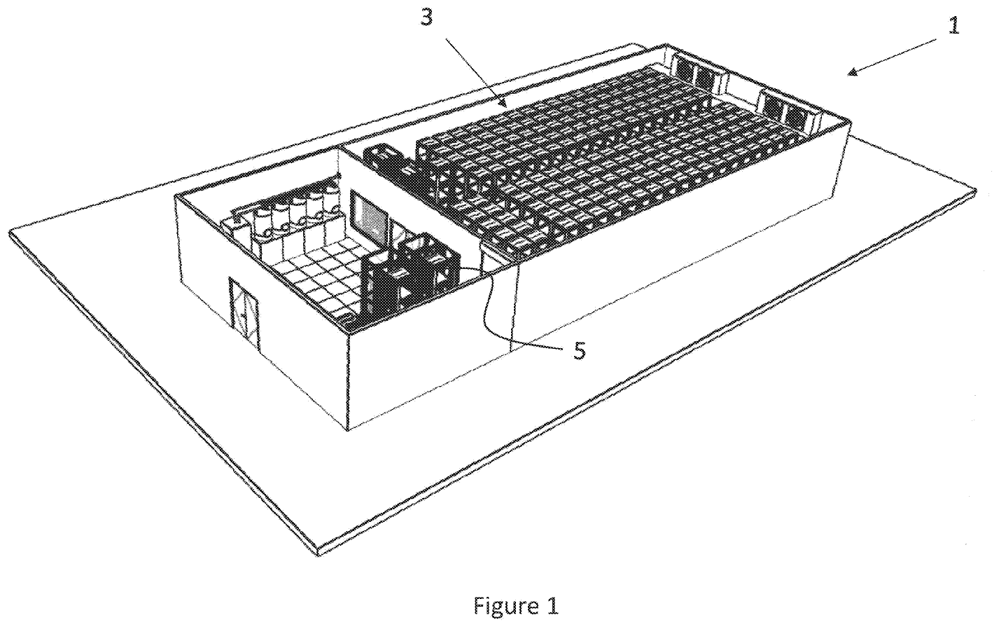

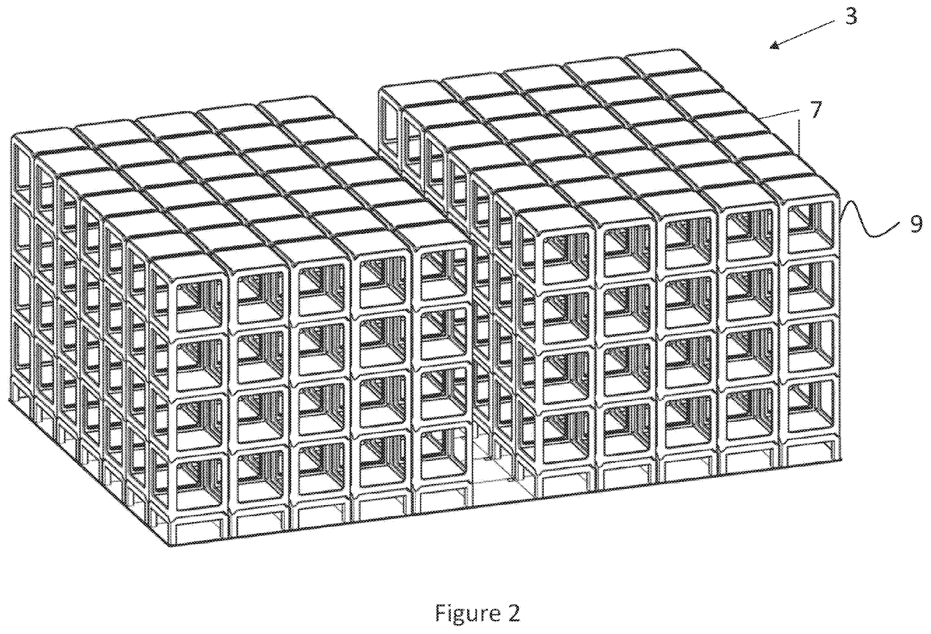

Referring to the drawings in detail, FIG. 1 shows an example of an automated growth system 1 according to the present invention. The growth system 1 comprises a growth station 3 comprising a storage structure for vertically farming one or more types of living organisms and a service station 5 for caring of the living organisms. For the purpose of the present invention, living organisms is understood to include all Eukaryota (Plantae, Fungi, Animalia), that is, all multicellular plants, fungi and animals; and all Prokaryota (Bacteria, Archaea, Protozoa, Chromista), that is, all unicellular microorganisms such as protists, bacteria, and archaea. Plants are to be broadly construed to generally refer to any living organism which absorbs water through a system of roots, and/or which synthesizes nutrients by photosynthesis. The basic building blocks of photosynthesis are carbon dioxide, water and light. Such plants include but are not limited to agriculture crops, grass, cane shrubs, trees of a certain size, herbs, ferns and mosses. The living organisms are stored in a storage structure comprising a plurality of vertical stacks of modular growth units 7 for carrying the living organisms (see FIG. 2). The plurality of stacks of modular growth units 7 are arranged in a grid pattern to form a freestanding grid structure. In the particular embodiment of the present invention, individual modular growth units 9 each have a box-like structure which can a cuboidal shape so as to allow the individual growth units to be densely packed in rows and columns, and thereby occupy a relatively small footprint. Further detail of the storage structure is discussed below.

To care for the living organisms in the individual growth units, the automated growth system shown in FIG. 1 further comprises one or more standalone service stations 5 for providing one or more services to the living organism and/or gathering data on the living organism. In the case, where the living organism are plants, such services include watering, trimming, drainage, harvesting and/or gather data on plants. The one or more service stations 5 are located remotely of the growth station 3 in the sense that they do not form part of the storage structure of the growth system. In the particular embodiment of the present invention shown in FIG. 1, one or more service stations 5 are located in a separate room to the growth station 3. The separation between the growth station 3 and the service station 5 helps to prevent contamination of living organisms by water borne contaminants from adjacent modular growth units during feeding of the living organisms. This is in contrast to prior art systems which support a plurality of trays in a rack, where each of the trays in the rack is provided with dedicated feeding tubes, drainage tubes, and/or lighting units. Not only does this setup require lengthy tubing running between the individual trays and the service station, but in a majority of cases, services to the living organisms in the trays do not need to be operational all of the time. In the case of plants, services to the plants such as watering would need to operational at least twice during a 24 hour period and therefore, such feeding tubes would tend to remain dormant for most of the time. Separating one or more service stations 5 from the growth station 3 removes this problem, since the one or more service stations are shared amongst a plurality of the modular growth units in the storage structure. Providing services could involve periodically transporting one or more stacks of the modular growth units to the service station(s) 5 depending on the type of living organism contained within the modular growth unit and/or the stage of the living organism in its growth cycle. In this way, the one or more service stations 5 are operational most of the time so providing a more efficient and cost effective vertical farming system, since periods where the service station remain dormant are greatly reduced. Further detail of the operation of the service station is discussed below.

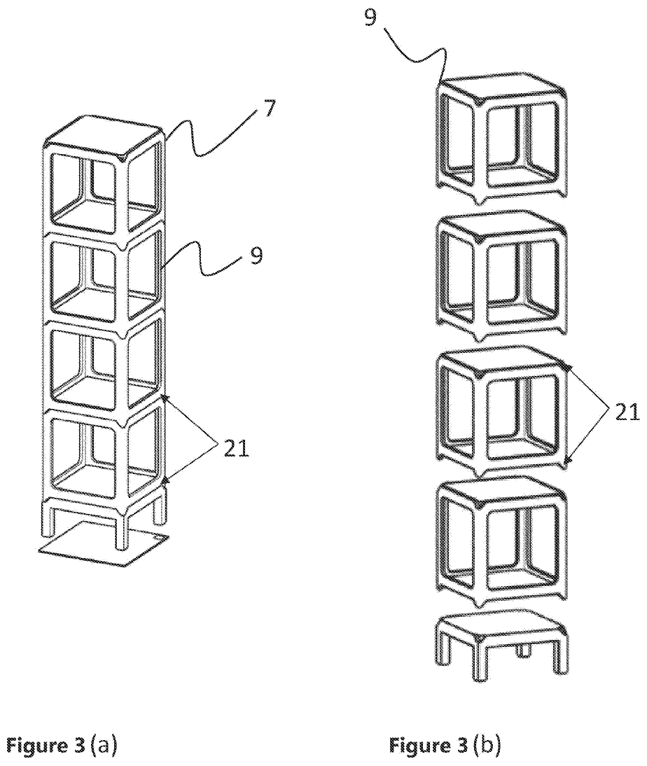

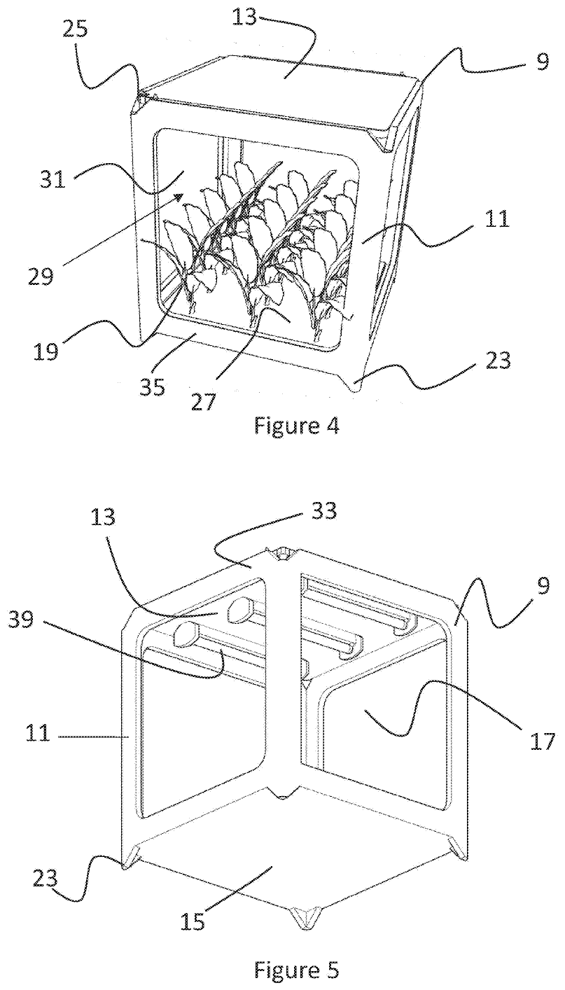

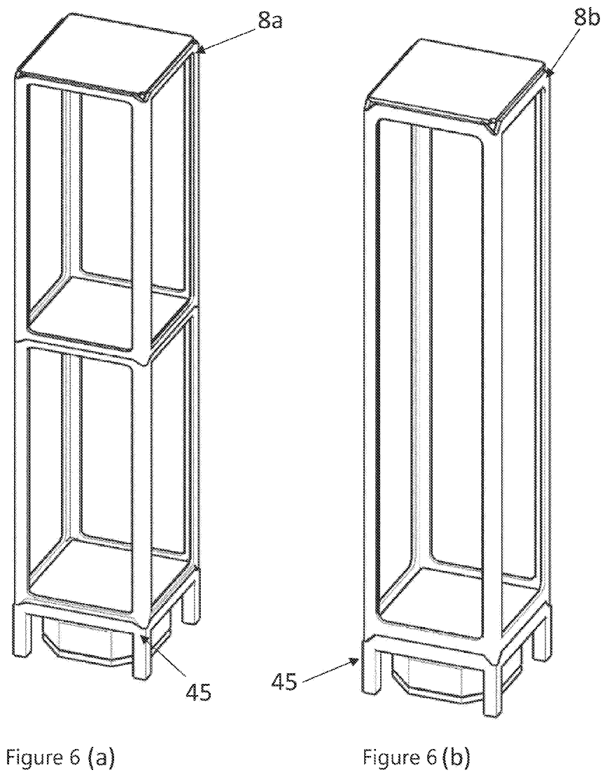

Referring to the storage structure, more specifically to FIG. 2, a plurality of stacks of modular growth units 7 are assembled together to form a three dimensional freestanding storage structure. Each of the growth units 9 making up a stack of growth units has a box-like structure comprising opposing sidewalls 11, a top wall 13 and a bottom wall 15 (see FIGS. 4 and 5). The opposing sidewalls 11, top 13 and bottom 15 walls of a single modular growth unit 9 enclose an interior space 17 for accommodating a living organism 19. In the particular embodiment of the present invention shown in FIG. 4, the individual modular growth units 9 have a cuboidal shape. This permits the individual growth units to be densely packed together so increasing the density of farming living organisms over a given footprint of the storage structure. The cuboidal shape allows the individual growth units to a stacked one on top of the other to form a stack of modular growth units as shown in FIG. 3(a) and FIG. 3(b). Individual stacks of modular growth units 7 allows for expansion of the storage structure simply by adding one or more vertical stacks of modular growth units 7 to an existing assembly of stacks of modular growth units. In the particular embodiment of the present invention shown in FIG. 2, stacks of modular growth units 7 are arranged in a grid pattern to form a storage structure comprising two 5×7 modular growth units. Any number of stacks of modular growth units 7 can be assembled together to provide a different storage capacity of the storage structure.

However, the cuboidal shape of the box-like structure is not limited to a regular cube shape as shown in FIG. 4 in order to provide a densely packed storage structure. The term cuboidal also covers other shapes including but not limited to a rectangular cuboidal shape as shown in FIG. 6(a) and FIG. 6(b). FIG. 6(a) and FIG. 6(b) show different cuboidal box-like structures 8a, 8b of the modular growth unit having different heights. The different heights of the box-like structure allows to accommodate different height of plants or even trees within the interior space of the box-like structure, yet permit the modular growth unit to nest neatly within the storage structure without greatly affecting the packing density of the modular growth units or disrupting any one of the modular growth units in the storage structure.

To stabilise the individual stacks of modular growth units in the storage structure so as to provide a free standing storage structure, the modular growth units are able to interlock with each other in a stack. In the particular embodiment shown in FIG. 3(a) and FIGS. 3(b) and 4, the top and bottom walls of each individual modular growth unit are provided with interlocking, self-aligning features 21 so as to enable each modular growth unit to interlock with one or more adjacent modular growth units in a stack. The interlocking features in the particular example of the present invention use complementary depressions and projections. The interlocking features 21 are shown in FIG. 4 disposed at the corners of the cuboidal shape of the modular growth unit. Four projections 23 are shown extending downwardly from the bottom wall 15 of the growth modular unit 9 that are shaped to be received in complementary depressions 25 in the top wall 13 of an adjacent modular growth unit in a stack. When assembling the individual growth units together in a vertical stack as shown in FIG. 3(a) and FIG. 3(b), a first modular growth unit is placed on top of a second modular growth unit such that the bottom wall of the first modular growth unit superimposes the top wall of the second modular growth unit and their respective interlocking features interlock with each other. The projections 23 are wedged shaped so as to permit adjacent modular growth units to self-align when vertically stacked.

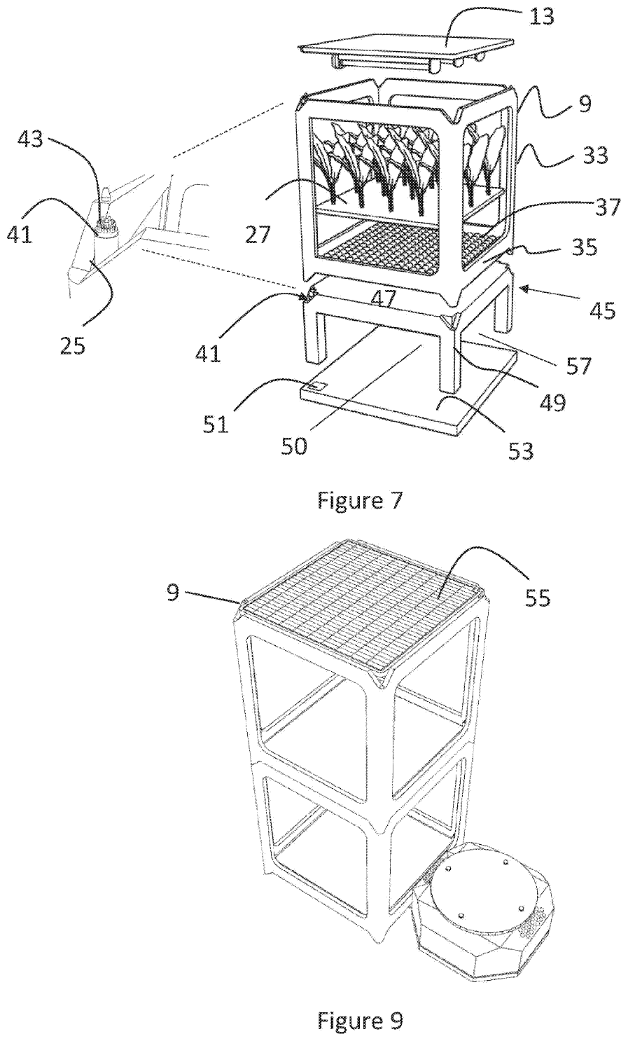

The box-like structure of the modular growth unit enclosed by opposing sidewalls provides an interior space 17 for accommodating a growth medium 27 to support the growth of living organisms 19, more specifically to support the roots of plants. Typically, for a hydroponic vertical farming system which necessitates the use of a growth medium to support the roots of plants, the growth medium can comprise Rockwool®, coconut coir, perlite, vermiculite or a combination thereof. One or both opposing sidewalls 11 of the modular growth unit comprises a window 29 having an opening 31 that extends into the interior space 17 of the modular growth unit 9. This is to allow one or more operations such as a fluid delivery system, a fluid drainage system and/or inspection system to enter into the interior space externally of the modular growth unit. This in turn, allows one or more services to be provided to care for the living organisms externally of the growth unit. For example, a stack of the modular growth units can be transported to a service station where the service station can easily access the living organisms contained within the interior space of the modular growth units externally of the modular growth units with minimum operation to provide one or more services to the living organisms. The opening of the window is such as to provide a frame 33 around the opening 31. The frame 33 cooperates with the bottom wall 15 to provide a lip or rim 35 around the perimeter of the bottom wall 15 to define a tray integrated within the box-like structure of the modular growth unit for accommodating the growth medium and/or containing fluid necessary to feed the living organism (see FIG. 7).

In the particular embodiment shown in FIG. 7, the tray integrated within the box-like structure of the modular growth unit comprises a plurality of upwardly standing protrusions 37. The growth medium 27 is configured to rest on the plurality of upwardly standing protrusions 37 such that the space between the bottom wall of the modular growth unit and the growth medium defines a volume within the tray for accommodating excess fluid and prevents the growth medium from being over saturated with fluid. Fluid deposited within the tray are absorbed by or ingresses within the growth medium 27 by the hydroscopic nature of the growth medium, e.g. by capillary action, up to a saturation limit of the growth medium. Furthermore, any debris or dead roots are contained within the volume defined by the space between the growth medium and the bottom wall.

In contrast to the bottom wall of the modular growth unit, the top wall 13 comprises a lighting unit 39 that is configured to illuminate the region occupied by the interior space 17 of the modular growth unit 9 (hereinafter called “the growth region”). In the particular embodiment of the present invention, the lighting units 39 comprise a plurality of light emitting diodes (LEDs) mounted to the inside face of the top wall of the box-like structure of the modular growth unit as shown in FIG. 5. Various fasteners commonly known in the art can be used to mount the lighting unit to the top wall of the modular growth unit. These include but are not limited to various screws, adhesives etc. The wavelengths of each of the LEDs are selected to drive photosynthesis of plants grown within the interior space of the modular growth unit. For example, individual LEDs may be selected to emit one or more wavelengths in one of the blue, orange, red spectral regions. Such spectral regions are selected since it is found that that blue and red wavelengths drive photosynthesis. Whilst the lighting units 39 shown in the particular embodiment of the present invention in FIG. 5 are tubular, extending longitudinally across the width of the modular growth unit, the present invention is not limited to any particular shape or orientation of the lighting unit. For example, the shape of the lighting unit may be circular, linear, square grid or any other shape. Each LED in the lighting unit may be individually and selectively powered by a controller so as to illuminate the interior space, and thus the plants, with an artificial light at a desired wavelength in order to maximize plant growth and yield.

The top wall 13 can be integrated into the box-like structure of the modular growth unit 9. In fact, the box-like structure of the modular growth unit can be formed as a single or unitary integrated body, e.g. by casting or moulding. The windows 29 in the opposing sidewalls 11 may be integrally formed with the body of the box-like structure, or alternatively, may be machined from the opposing sidewalls of an integrally formed box-like body. Various materials can be used to fabricate the modular growth unit according to the present invention. These include but are not limited to various plastics, metals, wood, ceramics or even composite materials. Alternatively as depicted in FIG. 7, the top wall 13 can be formed as a separate part to the rest of the body of the modular growth unit 9 so as to define a lid to enclose the interior space of the modular growth unit. The advantage of mounting the lighting unit 39 to a lid forming the top wall 13 of the modular growth unit 9 is the ability to replace any one of the LEDs should any one of the LEDs malfunction, or to change the spectral wavelength of the light illuminated from the lighting unit, e.g. light capable of providing seasonal and/or daily cueing.

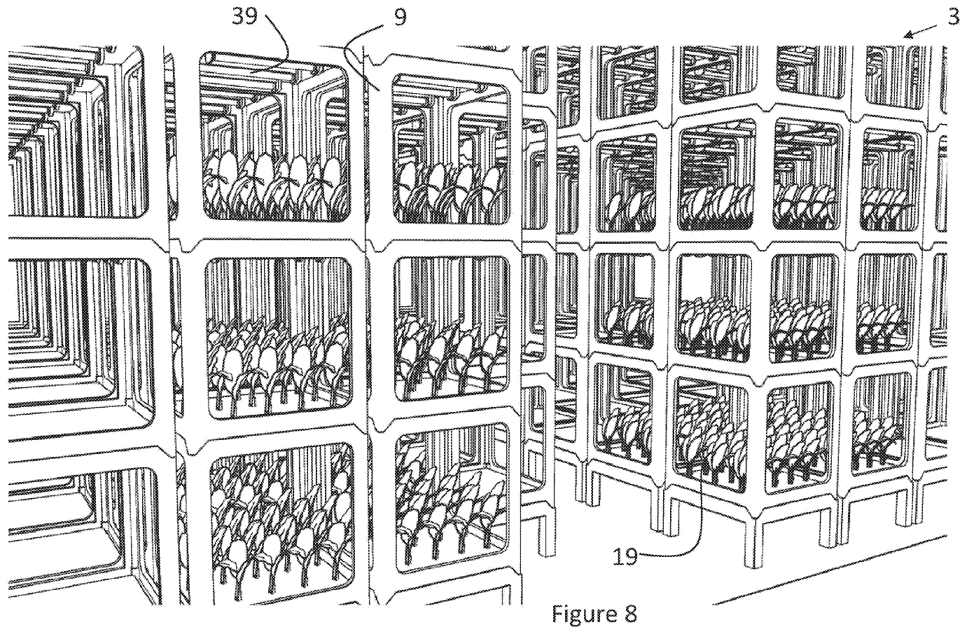

FIG. 8 shows the storage structure comprising an assembly of the interlockable modular growth units 9 arranged densely into a plurality of closely spaced vertical stacks. Each of the modular growth units 9 in the storage structure is shown to have a dedicated lighting unit 39 as discussed above that is arranged to illuminate the interior space of the living organisms 19 within their respective modular growth units 9. As shown in FIG. 8, the interlockable modular growth units 9 are arranged in vertical stacks to provide a vertical farming system. To supply power to the lighting units of each of the modular growth units in the stack, each of the modular growth units comprises an electrical interface portion that is configured to electrically couple with an adjacent modular growth unit in the stack. A plurality of modular growth units are arranged in a stack of modular growth units such that electrical continuity is established between adjacent modular growth units in the stack. This allows power to be supplied to each of the lighting units in a given stack from a single electrical interface mounted to the stack that is configured to electrically couple with an external power source. Power is thus supplied from the external power source to each of the modular growth units by the electrical connection established between respective electrical interfaces of adjacent modular growth units in a given stack. In the particular embodiment of the present invention shown in FIG. 7, electrical continuity between adjacent modular growth units is established by an electrical connection being made when adjacent modular growth units interlock with each other in a stack. To provide this electrical connection when adjacent modular growth units interlock with each other, the electrical interface 41 is incorporated within the interlocking features 21 of each of the modular growth units. Various types of electrical connections known in the art can be used to establish an electrical connection between adjacent modular growth units in a stack. These include but are not limited to spring based electrical contacts, electrical plug-socket type connectors, and even wireless connection comprising a transmitter coil and a receiver coil to inductively transmit electrical signals. In the particular embodiment of the present invention shown in FIG. 7, electrical coupling between adjacent modular growth units in a stack comprises a plug-socket type electrical connector 43. The electrical interface between adjacent modular growth units can optionally comprise a magnet (not shown) that relies on the magnetic force of the magnet to help guide and make electrical connection between the electrical interfaces in a stack.

The modular growth units may further comprise other electrically powered devices for providing services to the living organisms. For example, the modular growth units may be provided with heating elements to control the temperature of the growth medium, or of the air within the interior space. The heating elements may be separate from the lighting unit 39. For example, the heating elements may be integrated into the bottom wall of the modular growth units in order to provide heat directly to the growing medium. Alternatively, in some examples the lighting unit can also be configured to produce heat.

Other examples of electrically powered devices for providing services to the living organisms include sensors and monitoring equipment. For example, the modular growth units may be provided with thermometers for monitoring temperature (of the air, the growth medium, or the organisms themselves), humidity meters for measuring humidity, pH meters for measuring the growth medium, or other monitoring devices. Another example of an electrically powered device for providing services to the living organisms is a status indicator, which may indicate the status of the living organism. For example, the status indicator may show a green light if a monitored parameter such as temperature, humidity etc. is within the expected range, or a red light if the monitored parameter is not within the expected range. Alternatively or additionally, a status indicator may indicate whether a rechargeable power source on the modular growth unit needs to be charged.

To transport any one stack of modular growth units to and from the growth station and the service station, the stack of modular growth units are supported on a stand 45 which raises the stack above the ground. The stand 45 (shown more clearly in FIG. 7) comprises a stand top 47 on which the stack is located and legs 49 extending downwardly from each corner of the stand top 47. The stand 45 can be used as a means to electrically couple the lighting units in each of the modular growth units to an external power source 51. For example, as shown in FIG. 7, at least one of the legs comprises an electrical interface that is configured to electrically couple with an external power source 51 integrated into the floor 53. Like the interlocking features between adjacent modular growth units in a stack, the stand top comprises interlocking features that are configured to interlock with a modular growth unit mounted thereon. Thus, power from the external power source can be supplied to the individual modular growth units in a stack via the electrical coupling of the stand 45 with the external power source 51.

A stack of the modular growth units can also comprises a rechargeable power source 55 that is arranged to supply power to the lighting units to each of the modular growth units in the stack via their respective electrical interface. The rechargeable power source 55 can receive power from when the stack is electrically coupled to an external power source. Examples of rechargeable power sources include but are not limited to rechargeable batteries and capacitors. Examples of batteries include lithium ion batteries, lithium-ion polymer batteries, lithium-air batteries, lithium-iron batteries, lithium-iron-phosphate batteries, lead-acid batteries, nickel-cadmium batteries, nickel-metal hydride batteries, nickel-zinc batteries, sodium-ion batteries, sodium-air batteries, thin film batteries, solid state batteries, or smart battery carbon foam-based lead acid batteries. Examples of capacitors include capacitors, supercapacitors, ultracapacitors, lithium capacitors, electrochemical double layer capacitors, electric double layer capacitors, pseudocapacitors, or hybrid capacitors. Combinations of different rechargeable power sources can also be used, for example a supercapacitor for fast charging, and a battery for energy density.

The rechargeable power source 55 can be mounted or integrated into the top wall of the box-like structure of the modular growth unit 9 as shown in the example in FIG. 9. The incorporation of a rechargeable power source into a stack provides the ability to continuously supply power to the lighting units when the stack is decoupled from the external power source. Thus, if the stack is decoupled from an external power source for any length of time, the lighting unit is still supplied with power from the rechargeable power source so that the living organism continuously receives light from the lighting units. When the living organism is scheduled to receive at least a prescribed amount of light from the lighting unit, any disruption to the power to the lighting unit is minimised by receiving power from the rechargeable power source.

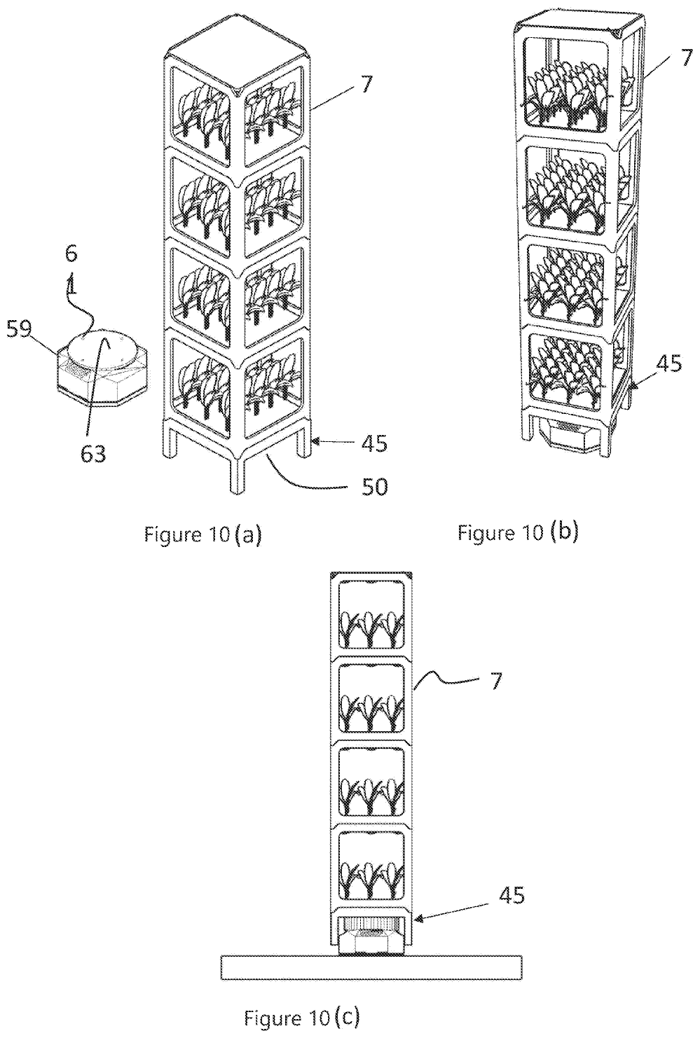

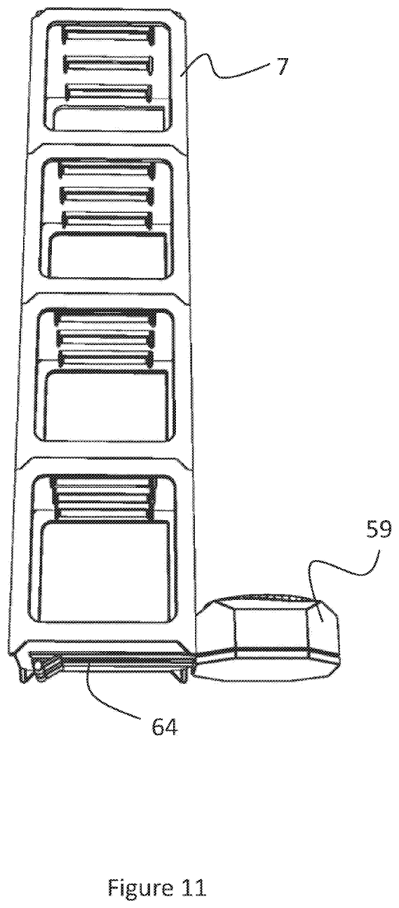

The stand top 47 and legs 49 define a space 50 underneath the stand top that is accessible from the side via one or more side openings 57 defined between adjacent legs. In the example shown in FIG. 7, the stand top 47 has a rectangular (square) shape with four legs extending downwardly from the corners and a side opening 57 on each side of the stand. FIG. 10 (a to c) shows the stages in transporting a stack 7 of the modular growth units. FIG. 10(a) shows a transport means 59 (e.g. an AGV or AMR) approaching the underneath of the stand 45 and FIG. 10(b) shows the transport means 59 underneath the stand 45. The purpose of the transport means 59 is to lift and transport the stack of modular growth units 7 to different locations, in the particular case to and from the service station.

As shown in FIG. 10(a) and FIG. 10(b), the transport means 59 is dimensioned so that it can enter and occupy the space 50 underneath the stand top 47 via any of the side openings 57. The transport means 59 is preferably dimensioned so that it does not laterally extend beyond the stand top 47 when it is occupying the space 50. The top of the transport means and the bottom of the stand top can also comprise interlocking features 61. In particular, the top of the transport means can comprise upwardly extending protrusions 61 which interlock with corresponding recesses (not shown) in the underside of the stand top so that the stand rests more securely on the transport means when it is being lifted.

In order to move the stack, the transport means 59 additionally comprises a lifting mechanism for lifting the stand once the transport means is positioned underneath the stand top. The transport means comprises a lifting surface 63 (on which the protrusions are located) which is vertically moveable relative to the body of the transport means between a lowered position and a raised position. In the lowered position shown in FIG. 10(b), the lifting surface 63 is not engaged with the stand. In the raised position shown in FIG. 10(c), the lifting surface 63 is engaged with the underside of the stand top and the overall height of the transport means increases such that the stand is lifted completely off the ground and is solely supported by the lifting surface 63. Once the lifting surface 63 is in the raised position, the transport means 59 can transport the stack unit to a desired location, e.g. the service station. Once the stack unit has been transported to the desired location, the lifting surface 63 can be moved to the lowered position to place the stack unit back on the ground. The desired location can also include an external power source such that when the transport means lowers the stack at the desired location, the stack of modular growth units electrically couples to an external power source. In the particular embodiment of the present invention, the transport means positions the stack such that the electrical interface in one of the legs of the stand is positioned directly above an external power source. The electrical interface electrically couples with the stand when the stand is lowered onto the external power source. The transport means can then exit the space 50 and move to a different location (e.g. to a different stack unit).

However, other means to move a stack of modular growth units besides the use of a stand is applicable in the present invention. In another example, the transport means can have a built in fork lift that is sized to be received underneath a stack of modular growth units as shown in FIG. 11. The interlocking protrusions downwardly extending from the bottom wall of the lowermost modular growth unit in a stack raises the stack above the ground to provide a space sufficient for receiving the forks 64 of the fork lift.

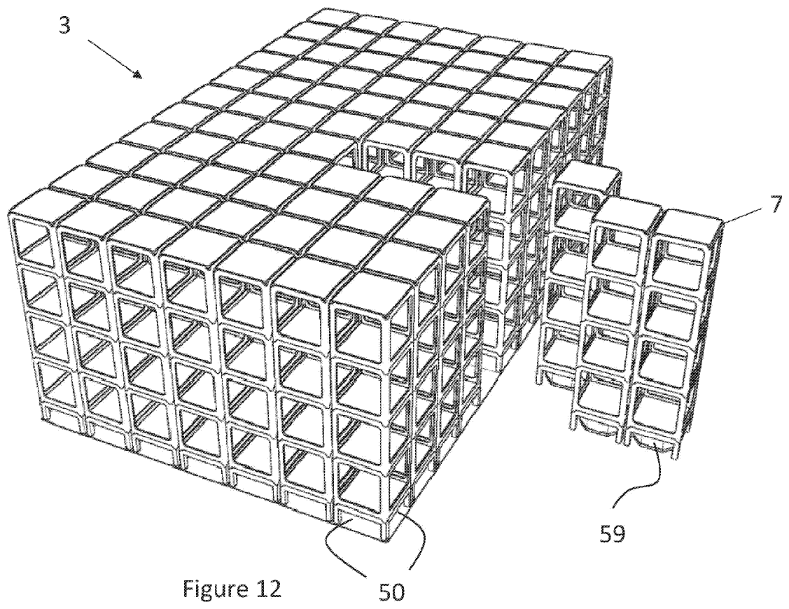

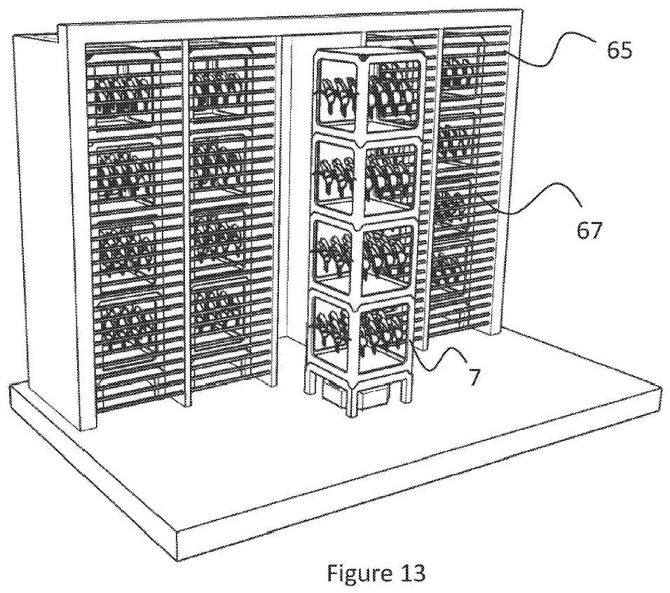

The advantage of the use of a stand 45 for providing an intermediate stand between the stack of modular growth units and the transport means is that when a plurality of stack of modular growth units are arranged densely together in a grid like pattern as shown in FIG. 2, the spacing 50 under a plurality of stands cooperate with each other to define a clear path or route underneath a plurality of stacks of modular growth. One or more side openings 57 defined between adjacent legs 49 of the stand 45 allow the transport means to move into the space underneath a given stack from more than one direction. For example, the stand top 47 may have a rectangular shape with four legs extending downwardly from the four corners of the stand top. A side opening may be defined on each side of the stand, between each adjacent pair of legs. In this way, the transport means can move into and out of the space 50 underneath the stand top 47 regardless of the orientation of the stack of modular growth units 7. Furthermore, if the stacks of modular growth units 7 are arranged in a grid pattern such that the side openings 50 on adjacent stack units are aligned, then the transport means can efficiently travel from one side of the grid pattern to another side by travelling “through” the grid pattern, rather than having to travel around the outside of the grid pattern. This also allows the stacks to be more densely arranged because clear access routes are not required between the stack units as demonstrated in the schematic drawing of the storage structure shown in FIG. 12. To access a particular stack of modular growth unit, the transport means 59 can simply enter the spacing 50 underneath a stack 7 and move the stack out from the storage structure 3. If the stacks are densely packed, then one or more of the stacks of modular growth units would have to be moved in order to gain access to a stack buried within the storage structure.

Where one or more living organisms require storage in a specific environment in comparison to the other living organisms in storage, one or more stacks of modular growth units housing the living organisms can be stored in separate enclosures 65 that are equipped with one or more devices (not shown) to provide a specific growing environment. The one or more devices include but are not limited to humidity and temperature control devices, e.g. heater and/or refrigeration devices, to control the humidity and temperature of the environment respectively. In the particular embodiment of the present invention shown in FIG. 13, the one or more enclosures 65 are provided by one or more drive-in cabinets that are sized to accommodate a vertical stack of modular growth units 7. Each of the one or more enclosures 65 comprises an entrance to receive a stack of modular growth units 7. The entrance comprises a door 67 to close the space within the enclosure from the external environment once a stack of modular growth units is moved into the enclosure 65. The door 67 can be manually operated or operated automatically in response to one or more sensors (not shown) at the entrance or within the enclosure sensing the presence of a stack of modular growth units within the enclosure. Examples of sensors include but are not limited to position sensors, infra-red sensors etc. In operation, a transport means can be instructed to move a stack of modular growth units requiring storage in a special environment into the enclosures via the entrance. Once the enclosure senses the presence of a stack of modular growth units in the enclosure, the door is closed and the environment in the enclosure is controlled to a prescribed temperature and/or humidity depending on the type and/or growth stage of the living organism grown in the stack of modular growth units.

To care for the living organisms in storage, the transport means transports one or more stacks of the modular growth units to one or more service stations depending on the status of the living organism grown in their respective modular growth units. The one or more service stations provide one or more services to care for the living organisms grown in the modular growth units. The frequency with which one or more stacks of modular growth units are transported to a service station can be prescribed depending on the stage of growth of the living organism in its growth cycle and/or the type of living organism grown. For example, tomatoes require more frequent visits to the service station for watering in comparison to herbs such as mint, thyme etc.

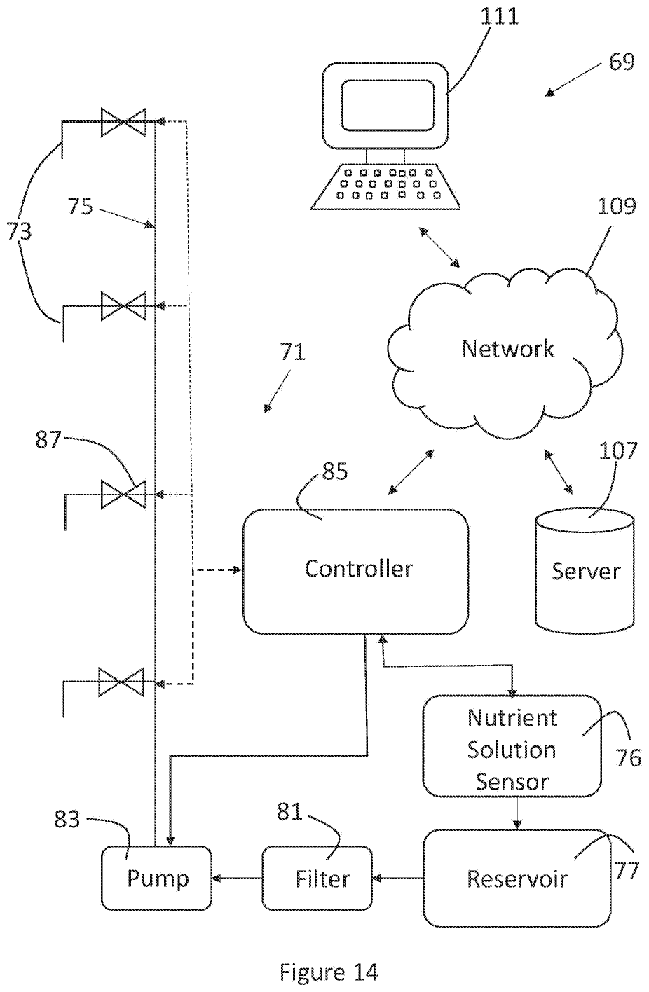

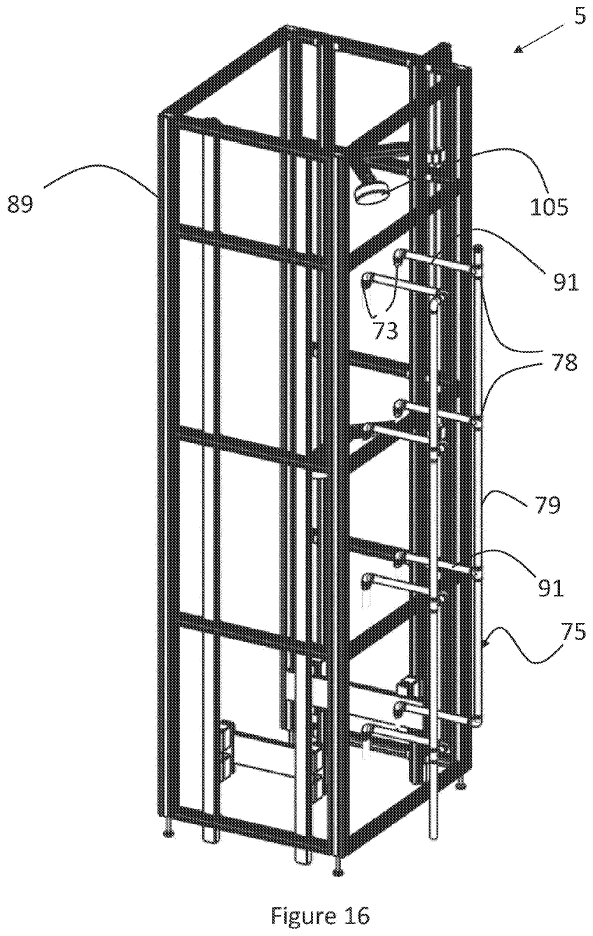

A schematic drawing of a nutrient feeding system 69 for autonomously supplying feed to the living organisms in one or more growth modular units in a stack is shown in FIG. 14. The system includes a fluid delivery system 71 configured for supplying fluid to the individual growth modular units in a stack to promote growth of the crops. The fluid delivery system 71 comprises a plurality of down tubes 73 in fluid communication with a common fluid distribution system 75 that is arranged to be in cooperation with one or more reservoirs 77 containing a solution of water and one or more nutrients to promote crop growth. The common distribution system 75 comprises a network of conduits or tubing that distributes fluid to each of the growth modular units in a stack. One or more manifolds may form part of the common distribution system 75 and used to distribute the fluid from the reservoir to each of the modular growth units. In the particular example of the nutrient feeding system shown in FIG. 16, multiple “T” joints 78 are used to branch out the fluid from a single pipe or tubing 79 to each of the downpipes 73 that is configured to supply fluid to each of the modular growth units in a stack. A filter 81 can used in fluid communication with and downstream of the reservoir for removing any undesirable impurities from the reservoir. One or more nutrient solution sensors 76 may be associated with the reservoir 77 and configured for detecting any one of pH, electro-conductivity, temperature, and nutrient levels of the fluid in the reservoir. Data from the nutrient solution sensor is fed to a controller 85 which can use the data to control the quality of the fluid in the reservoir. Not shown in FIG. 14, the one or more nutrient feeding tanks can feed nutrients to the reservoir in response to the data from the nutrient solution sensors 76. A pump 83 in fluid communication with and downstream of the filter 81 is configured for drawing the fluid from the reservoir 77 and through the filter 81 where it is fed into the common distribution system 75. The pump 83 is controlled by the controller 85 that is configured to control the flow of fluid from the reservoir 77 to the common distribution system 75. The flow of fluid to the common distribution system 75 can be controlled dependent on the status and/or type of the living organism grown in the plurality of modular growth units. One or more non-return valves 87 may be incorporated to each of the branches supplying the down tubes 73 and controlled by the controller 85 to selectively and/or independently control the flow of fluid from the common distribution system 75 to one or more of the branches of the down tubes 73 which in turn, controls the flow of fluid to one or more modular growth units in a stack.

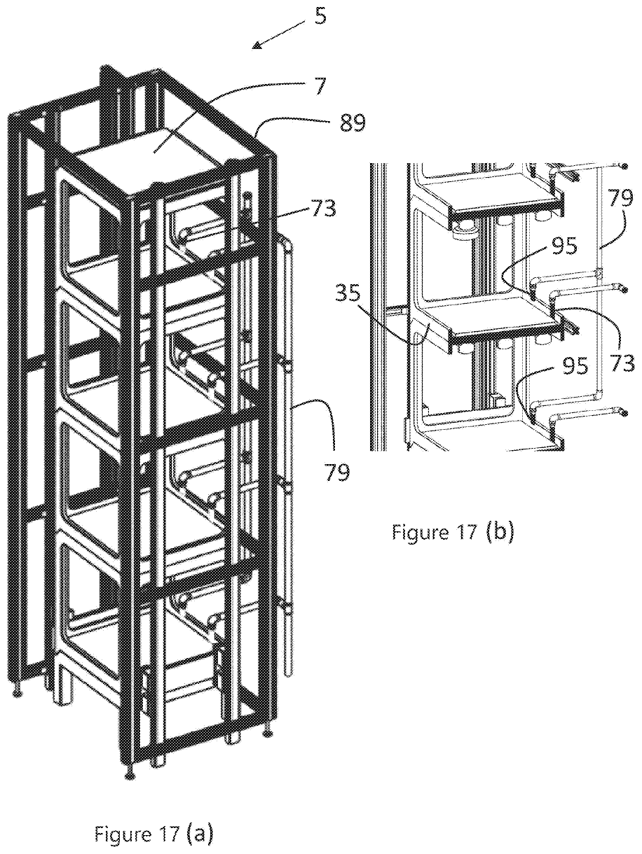

In order to engage with the stack of modular growth units, the plurality of down tubes 73 branching out from the common distribution system 75 are arranged as a plurality of vertically spaced apart down tubes or down pipes 73. The spacing between each of the down tubes is such so as to be received within respective trays of the modular growth tray in a stack when the stack of the modular growth units docks at the service station (see FIG. 17). To support the plurality of down tubes 73 spatially so that the plurality of down tubes engages with the plurality of vertically spaced modular growth units in a stack, the plurality of down tubes are mounted to a frame 89 that is sized to accommodate a vertical stack of modular growth units as shown in FIGS. 16 and 17. In the particular embodiment shown in FIG. 16, the common distribution system 75 comprising a single pipe or tubing 79 is mounted to the frame 89 and the down tubes 73 branches out from the single piping or tubing 79 by a series of “T” joints 78. An intermediate pipe or tube 91 can be interposed between single pipe 79 and the down tube 73 so as to set back the down tube 73 from the single pipe 79 and enable the down tube 73 to reach into the tray of the modular growth unit.

To enable the down tube to be received within the tray of the modular growth unit, at least a portion of the down tube 73 is resiliently deformable or foldable such that when the modular growth unit approaches the service station 5 and is received within the frame 89 of the service station as shown in FIG. 17(a) and FIG. 17(b), the down tube 73 butts up against the lip or rim 35 of the tray. Further movement of the stack of modular growth units into the service station 5 causes the down tube 73 to ride over the lip or rim of the tray and enter the tray as clearly shown FIG. 17(b). The resilient nature of the down tube 73 allows the down tube to deform, e.g. bend or fold, so as to be received within a tray of a given modular growth unit in a “flip and flop” type action over the lip of the tray. The stack of modular growth units is said to be docked at the service station when the down tubes are received within respective trays of the modular growth units in a stack. The docking area of the service station where the down tubes are able to be received within their respective trays can be termed the parking zone of the service station. Thus, the transport means 59 can be instructed to move the stack of modular growth units to the parking zone of the service station 5. One or more parking sensors, e.g. floor mounted sensors, can used to guide the transport means carrying a stack of modular growth units to the correct position within the service station. Examples of parking sensors include but are not limited to RFID tags, proximity sensors etc.

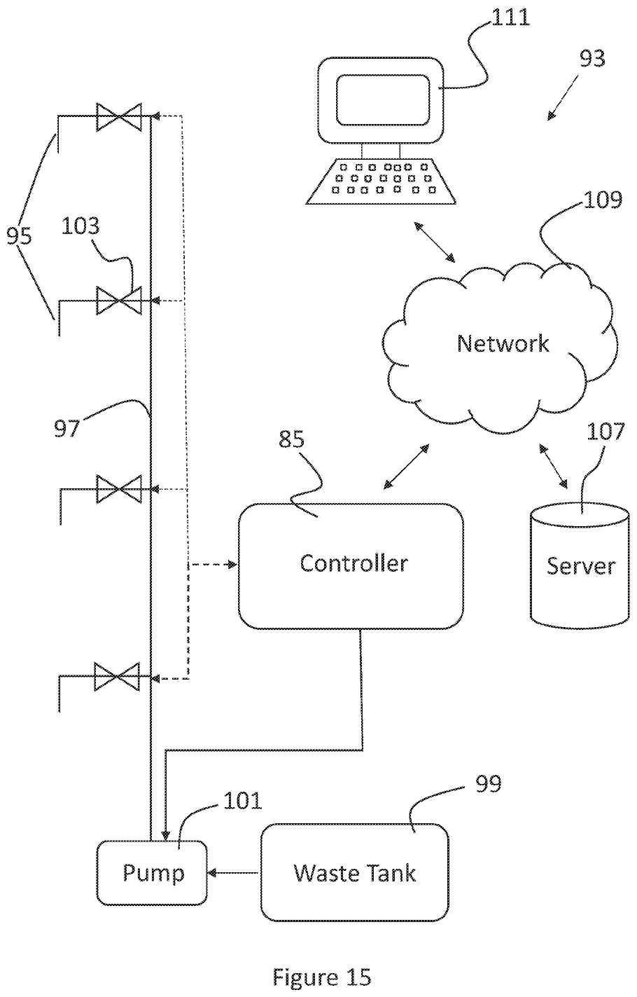

For a hydroponic system where nutrient solution is fed into the trays of the modular growth units, the service station may additionally comprises a fluid draining system 93 where waste and/or contaminated fluid can be drained from the trays so that fresh fluid from the fluid delivery system 69 can be fed into the trays. Like the fluid delivery system 69, the fluid draining system 93 comprises a plurality of down tubes 95 branching out from a single pipe or tube 97 in fluid communication with a waste water tank 99 (see FIG. 15). In comparison to the fluid delivery system, the reservoir is a waste water tank 99 for the storage of waste water from the trays. A second set of plurality of down tubes 95 are configured to be received within the trays of the modular growth units (see FIG. 17(b)). The first set of plurality of down tubes 73 are fluidly connected to the common distribution system discussed above. A pump 101 in fluid communication with and downstream of the waste water tank 99 draws fluid from the trays via the down tubes 95 into the waste water tank. Waste water from the waste water tank 99 can be recycled into the reservoir 77 for feeding the living organisms. For example, one or more filters (chemical and/or physical) (not shown) can be used to filter the water from the waste water tank to the reservoir. The pump is controlled by a controller 85 which controls power to the pump 101 to actuate the pump whenever there is a need to remove waste water from the trays of the modular growth units. As with the fluid delivery system, each of the down tubes 95 is fluidly connected to a one way valve 103 which is controlled by the controller 85 to selectively control actuation of each of the one way valves 103 to draw fluid from their respective trays via their respective down tubes.

Whilst in the particular examples shown in FIG. 17(a and b) a plurality of down tubes or down pipes 73, 95 are shown to engage with the stack of modular growth units, other means to deliver and/or drain fluid from the trays of the modular growth units are applicable in the present invention. These include but are not limited to the piping or tubing of the common distribution system fluidly coupling with one or more fluid connectors mounted to the modular growth units, e.g. male and female type fluid connectors. The fluid delivery system and/or the fluid drainage system of the service station fluidly couples with the fluid connectors mounted to the modular growth units, in particular to the box-like structure of the modular growth unit that is in fluid communication with their respective trays.

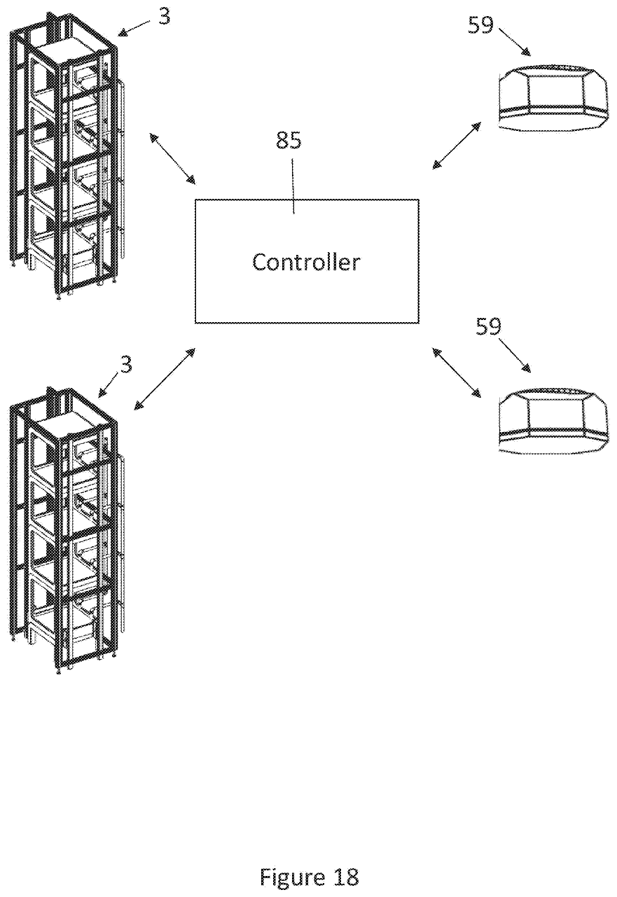

Movement of the transport means between the growth station 3 and the service station 5 is controlled by a controller 85. The controller 85 can be a separate controller for controlling the fluid delivery system and/or fluid draining system discussed above or the same controller, as shown in FIG. 18. The controller 85 comprises one or more processors and memory storing instructions that, when executed by the one or more processors, provide instructions to the transport means 59 in the form of wireless signals to control the movement of the transport means 59 between the growth station 3 and the service station 5. For example, a plurality of autonomous transport means 59 are wirelessly connected to the controller 85 such that each of the plurality of autonomous transport means is configured to send and/or receive the one or more signals to and from the controller indicative of the position of a respective autonomous transport means between the growth station and the service station. The wireless communication between the control system can be based on a short range wireless communication technology, e.g. Bluetooth®, or long range wireless communication, e.g. over a network. The network may comprise a local area network (LAN), a wide area network (WAN) or any other type of network.

The service station 3 may optionally comprise one or more cameras 105 to collect data and to monitor the characteristics of the living organism such as the size, height, colour, and other health attributes of the living organism (see FIG. 16). The data gathered can be used by the controller to control the amount of feed, e.g. water and nutrients that needs to be delivered to the living organism. The data can also be used to identify any living organisms in distress and requiring specialist treatment in order to recover. The data collected from the cameras 105 may be stored in a local memory or remotely on a server 107 via a network 109 such as, for example, over the internet. A personal computing device 111 may be in communication with the controller 85 through the network 109 and may include a software application or programme that is configured for displaying the data collected by the camera and selectively providing instructions to the controller to control the flow of fluid from the reservoir to each growth modular unit by independently controlling each of the one way valves.

Data collected from the cameras may be used by the controller 85 to generate different schedules of providing services to the living organisms grown in the stacks of modular growth units. The different schedules associated with any one of the stacks of modular growth units may depend on the growth of the living organism in its growth cycle and/or the type of living organism. The schedule includes the time at which a transport means retrieves a stack of modular growth units holding a particular living organism and transporting it to the service station to receive one or more services. Depending on the stage of growth of the living organism in its growth cycle and/or the type of the living organism, e.g. species, a first sub-group of the plurality of stacks of modular growth units in storage may be scheduled to receive services according to a first schedule and a second sub-group of the plurality of stacks of modular growth units may be scheduled to receive services according to a second schedule.

When a stack of modular growth units is scheduled to receive one or more services such as watering, a transport means is instructed by the controller to retrieve the stack of modular growth units from the storage structure or growth station and transports the stack to the service station. The transport means can identify a particular stack within the growth station 3 by the position of the stack within the storage structure. Since the plurality of stacks of modular growth units are arranged in a grid pattern, the position of a stack within the grid can be used to identify the stack within the storage structure. For example, each of the plurality of stacks are arranged in the grid pattern having an associated X-Y coordinate, and the X-Y coordinates can be used by the controller to locate a particular stack in storage. Alternatively or in combination with locating a stack within the storage structure by its position relative to the other stacks in storage, each or at least one of the modular growth units can comprise a label (not shown) to identify the living organism grown in the modular growth unit. The label can be attached to the box-like structure of the modular growth unit, and the label can comprise but is not limited to a barcode, RFID tag, QR code or other optical markers etc. The transport means can have a built in label sensor that is configured to read the label or optical marker. The label can carry data associated with the type of living organism and/or the position of the living organism within the storage structure.

Once a stack of modular growth units has been located within the storage structure, the transport means is instructed to transport the stack to a service station where it is docked at the service station such that the down tubes for feeding and/or drainage are received within their respective trays. The built-in rechargeable power source can still supply power to the lighting unit so as to continuously illuminate the living organisms whilst the stack is being transported to the service station. This has the advantage that should the service station be fully occupied servicing another stack of modular growth units, then the living organism waiting to enter the service station can still receive light from its lighting units.

Following servicing of the living organisms in the stack, the transport means returns the stack for storage in the storage structure. The service station can optionally comprise an external power source that is configured to electrically couple with the stack when the stack is docked at the service station. The external power source can be integrated into the floor of the parking zone of the service station such that when the transport means lowers the stack onto the floor, the stack electrically couples with the external power source. In the example discussed above, at least one of the legs of the stand comprises an electrical interface which electrically couples with the external power source when the stack is lowered onto the floor. When docked at the service station, the transport means is free to retrieve another stack of modular growth units from storage. Alternatively, the transport means can remain with the stack in the service station until the required care to the living organisms in the modular growth units has been completed.

The controller 85 in communication with the one or more transport means and the service station can provide instructions to the one or more transport means to retrieve a stack of modular growth units and transport them to the service station. The frequency by which one or more stacks of modular growth units are retrieved from the storage structure to be serviced by the service station can depend on a prescribed schedule, which can be based on the measured physical attributes of the living organism, e.g. growth stage of the living organism and/or type of living organism. Thus, the frequency by which a particular living organism is brought to the service station can vary based on the health and other physical attributes of the living organism. The physical attributes of the living organism can be derived from the data collected from the cameras at the service station as discussed above. Once living organisms in a stack have been serviced, the stack is returned to the growth station for storage in the storage structure.

1. A modular growth unit for forming a three dimensional extendible structure, the modular growth unit comprising:
a top wall;
a bottom wall; and
sidewalls extending between the top and bottom walls to define a box like structure having an interior space, the top and bottom walls including at least one interlocking feature configured to enable one modular growth unit to interlock with another modular growth unit when placed on top of each other in a stack, the bottom wall having a rim around a perimeter of the bottom wall configured to define a growth tray for receiving at least one growth medium for germinating, propagating and/or growing living organisms, and the top wall supporting a lighting unit configured to radiate light within at least one spectral region associated with selected growing living organisms when present within the interior space of box-like structure;
wherein a sidewall of the box-like structure includes a window having an opening extending into the interior space of the box-like structure so that the interior space of the modular growth unit is accessible externally through the window.

2. The modular growth unit of claim 1, wherein the interlocking feature comprises:
a male type interlocking feature and/or a female type interlocking feature.

3. The modular growth unit of claim 2, wherein the interlocking feature comprises:
a projection and/or a depression that are complementary in shape.

4. The modular growth unit of claim 1, wherein the modular growth unit is substantially parallelepiped in shape.

5. The modular growth unit of claim 1, wherein the modular growth unit is substantially cuboidal or cubic in shape such that the modular growth unit is interlockable with other modular growth units at two surfaces substantially opposite to each other.

6. The modular growth unit of claim 1, comprising:
at least one growth medium for germinating, propagating and/or growing living organisms.

7. The modular growth unit of claim 1, comprising:
an electrical interface for electrically coupling with another modular growth unit in a stack.

8. The modular growth unit of claim 7, wherein the electrical interface is integrated into the interlocking feature.

9. The modular growth unit of claim 7, wherein the electrical interface comprises:
a charge collector that is configured for coupling with a charge provider so as to provide power to the lighting unit.

10. The modular growth unit of claim 9, comprising:
at least one rechargeable power source electrically coupled to the charge collector for providing to power to the lighting unit.

11. The modular growth unit of claim 9, wherein the rechargeable power source is any one of a capacitor, supercapacitor and/or battery.

12. The modular growth unit of claim 9, wherein the charge collector comprises:
a wireless charge receiving coil that is configured and arranged for inductively coupling with a charge transmitter coil of the charge provider.

13. The modular growth unit of claim 9, wherein the charge collector comprises:
two charge receiving elements that are configured for receiving a direct current from two charge providing elements of the charge provider.

14. The modular growth unit of claim 9, wherein the charge collector is configured for coupling with a charge provider so as to provide power to one or more electrically powered devices for providing services to living organisms when present in the modular growth unit.

15. The modular growth unit of claim 14, wherein the one or more electrically powered devices for providing services to the living organisms comprise:
a heating element, a sensor, or a status indicator.

16. A modular growth unit of claim 1 in combination with a vertical farming system, the system comprising:
i) a growth station including one or more modular growth units, each of the one or more modular growth units including a modular of claim 1;
ii) a service station for providing one or more services to each of the plurality of the one or more growing units, the service station including:
(a) one or more reservoirs storing fluid containing one or more nutrients;
(b) a nutrient feeding system including a fluid delivery system in fluid communication with the one or more reservoirs, said fluid delivery system being configured to removably couple to each of the plurality of modular growth units so as to deliver fluid to the growth trays of each of the plurality of modular growth units,
iii) at least one transport means for transporting the one or more modular growth units between the growth station and the service station; and
iv) a controller communicatively coupled to the at least one transport means and including one or more processors and memory storing instructions that, when executed by the one or more processors, control movement of the at least one transport means to transport each of the one or more modular growth units from the growth station to the service station.

17. The system of claim 16, wherein the fluid delivery system comprises:
one or more delivery down pipes that are each configured to be removably receivable in the one or more trays of respective one or more modular growth units.

18. The system of claim 17, wherein each of the one or more delivery down pipes is deformable so as to enable the one or more delivery down pipes to resiliently deform when butted up against the rim of the tray of the modular growth unit and return to its original shape when received within the tray.

19. The system of claim 16, wherein the service station comprises:
a fluid draining system including one or more drainage down pipes that are configured to be removably receivable in the one or more trays of respective one or more modular growth units.

20. The system of claim 19, wherein each of the one or more drainage down pipes is deformable so as to enable the one or more drainage down pipes to resiliently deform when butted up against the rim of the tray of the modular growth unit and return to its original shape when received within the tray.

21. The system of claim 16, wherein the one or more modular growth units is mounted on a stand comprising
a stand top and a plurality of legs extending downwardly from the stand top so as to allow the transport means to enter below the one or more modular growth units, the stand top including at least one interlocking feature that is configured to be interlockable with the at least one interlocking feature of a modular growth unit, and wherein the transport means includes a lifting mechanism moveable between a raised position and a lowered position to raise the one or more modular growth units off the ground and lower the one or more modular growth units onto the ground respectively.

22. The system of claim 16, wherein the one or more modular growth units comprises:
a plurality of stacks of modular growth units.

23. The system of claim 22, wherein the plurality of stacks of modular growth units are arranged in a grid pattern.

24. The system of claim 22, wherein the controller is configured to instruct movement of the at least one transport means to transport each stack of the plurality of stacks of modular growth units from the growth station to the service station periodically or in a predetermined sequence.

25. The system of claim 22, wherein the controller is configured to instruct movement of the at least one transport means to transport each stack of the plurality of stacks of modular growth units from the growth station to the service station in a predetermined schedule corresponding to the feeding cycle of a living organism.

26. The system of claim 22, wherein the controller is configured to instruct the at least one transport means to move a first subset of the plurality of stacks of modular growth units from the growing station to the service station in a first schedule, and a second subset of the plurality of stack of growing units from the growing station to the service station in a second schedule, the first schedule being associated with a first feeding cycle of a first type living organism and a second schedule being associated with a second feeding cycle of a second type living organism.

27. The system of claim 16, wherein the service station comprises:
a charge provider that is configured for coupling with a charge collector.

28. The system of claim 16, wherein the growing station comprises:
one or more enclosures, each of the one or more enclosures being configured to house the one or more modular growth units in a predetermined environment.

29. The system of claim 28, wherein the enclosure comprises;
a heater and/or a humidifier.
